(19) United States
(12) Patent Application Publication
(10) Pub. No.: US 2014/0021788 A1
(43) Pub. Date: Jan. 23, 2014

(54) UNINTERRUPTED POWER SUPPLY AND DETECTION DEVICE

(71) Applicants: CHING-NAN YANG, New Taipei City (TW); Wu-Kun Shih, New Taipei City (TW); Wen-Chih Teng, New Taipei City (TW)

(72) Inventors: CHING-NAN YANG, New Taipei City (TW); Wu-Kun Shih, New Taipei City (TW); Wen-Chih Teng, New Taipei City (TW)

(21) Appl. No.: 13/555,207

(22) Filed: Jul. 23, 2012

(51) Int. Cl. H02J 9/00

(52) U.S. Cl. 307/64

(57) ABSTRACT

An uninterrupted power supply and detection device wherein a light fixture operates with and is coupled to a driving and linking module and a power supply wire. The driving and linking module connected to the power supply wire can sense a voltage state on the power supply wire. At this time, operation of the light fixture can be controlled by a wired or wireless switch of a control unit. When the voltage state is abnormal, the electricity detecting unit set in the driving and linking module can detect a signal representing abnormal power supply. Thereby, backup power can be supplied for driving emergency illumination of a light emitting element of the light fixture. Accordingly, original operation performed in a general power supply system can be kept and backup power can be supplied to keep illumination of the light fixture when the normal power supply is interrupted.

### BACKGROUND OF THE DISCLOSURE

a) Field of the Disclosure

The invention relates to an uninterrupted power supply and detection device, and more particularly, to an uninterrupted power supply and detection device for controlling operation of a light fixture using a wired or wireless switch in the state of normal voltage and also for supplying emergency power.

b) Brief Description of the Related Art

An emergency illumination device is a kind of illumination device continuing to provide a lighting effect in the interruption of power supply. Thereby, suitable illumination can be provided at home, working places and emergency accesses such that working can be closed in a short time or smoothly escaping and running away in emergency can be led.

Currently, most of emergency illumination devices on market are set at safe passages and path corners. Thereby, an illumination effect with suitable brightness still can be kept to show correct escape paths when regular power supply is interrupted. Recently, with improvement of home life quality, building designs emphasize not only comfort but safety.

However, this kind of emergency illumination device is provided with a switch for automatically switching between alternating and direct currents. Ordinarily, a specific direct current output from an alternating current can automatically charge a backup battery. The battery when being fully charged is automatically stopped to be charged. When power supply is interrupted, a backup circuit is automatically switched to and the backup source can supply electricity for emergency illumination.

Accordingly, inventors and firms in this industry are pursuing for solving the above conventional deficiencies.

### SUMMARY OF THE DISCLOSURE

In order to improve the above disadvantages, the inventors collected related information, had evaluation and consideration in many ways based on long experience in this field and straight did tests and modification, and finally an uninterrupted power supply and detection device for controlling operation of a light fixture using a wired or wireless switch in the state of normal voltage and also for supplying emergency power can be developed.

In accordance with an objective of the present invention, a user can use a wired or wireless switch to control operation of a light fixture in the state of normal power supply and an electric power also can be supplied for keeping the operation of the light fixture when the normal power supply is interrupted.

In order to achieve the above objective, an uninterrupted power supply and detection device, in accordance with the present invention, includes at least a driving and linking module containing an electricity charging unit, a power supply unit coupled to and operating with the electricity charging unit, a driving unit for starting operation of the power supply unit, a control unit and an electricity detecting unit operating with the driving unit. The driving and linking module is connected to a power supply wire, and a switch is set between the driving and linking module and the power supply wire. The driving and linking module operates with a light fixture.

Thereby, the driving and linking module connected to the power supply wire can sense a voltage state on the power supply wire. A normal voltage state means normal power supply on the power supply wire. At his time, a user can use a wired or wireless switch to control operation of the light fixture. When the voltage state is abnormal, the electricity detecting unit of the driving and linking module can detect a signal representing abnormal power supply. Thereby, an electric power also can be supplied for keeping the operation of the light fixture when the normal power supply is interrupted. Accordingly, wired detection to power supply and wireless control to the light fixture can be achieved.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a block flow diagram in accordance with an embodiment of the present invention.

FIG. 2 is a first schematic view in accordance with an embodiment of the present invention.

FIG. 3 is a second schematic view in accordance with an embodiment of the present invention.

FIG. 4 is a third schematic view in accordance with an embodiment of the present invention.

FIG. 5 is a fourth schematic view in accordance with an embodiment of the present invention.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

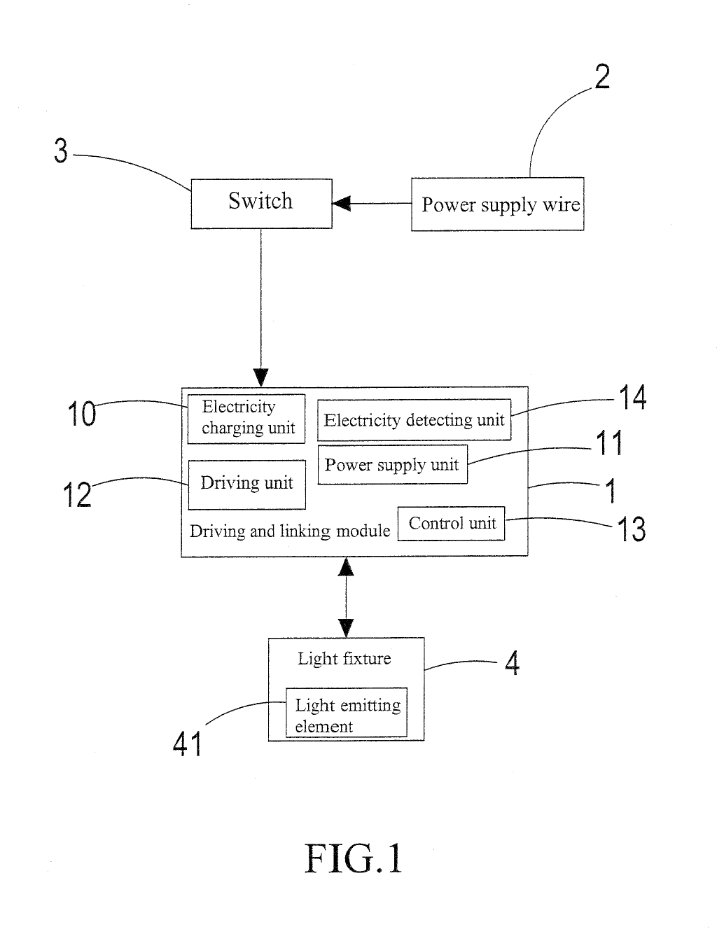

FIG. 1 is a block flow diagram in accordance with an embodiment of the present invention. Referring to FIG. 1, an uninterrupted power supply and detection device, in accordance with the present invention, includes at least a driving and linking module 1, an electricity charging unit 10 contained in the driving and linking module 1, a power supply unit 11 coupled to and operating with the electricity charging unit 10 and contained in the driving and linking module 1, a driving unit 12, for starting operation of the power supply unit 11, contained in the driving and linking module 1, a control unit 13 contained in the driving and linking module 1, wherein the control unit 13 can be a wired or wireless switch, wherein the wired switch can be a mechanical switch and the wireless switch can be a remote switch controller, and an electricity detecting unit 14 operating with the driving unit 12 and contained in the driving and linking module 1.

The driving and linking module 1 is connected to a power supply wire 2, and a switch 3 is set between the driving and linking module 1 and the power supply wire 2. The driving and linking module 1 operates with a light fixture 4, wherein the light fixture 4 may include at least a light emitting element 41, such as halogen lamp, incandescent lamp, fluorescent lamp or light emitting diode. The light fixture 4 can be a light bulb, light lamp or down light.

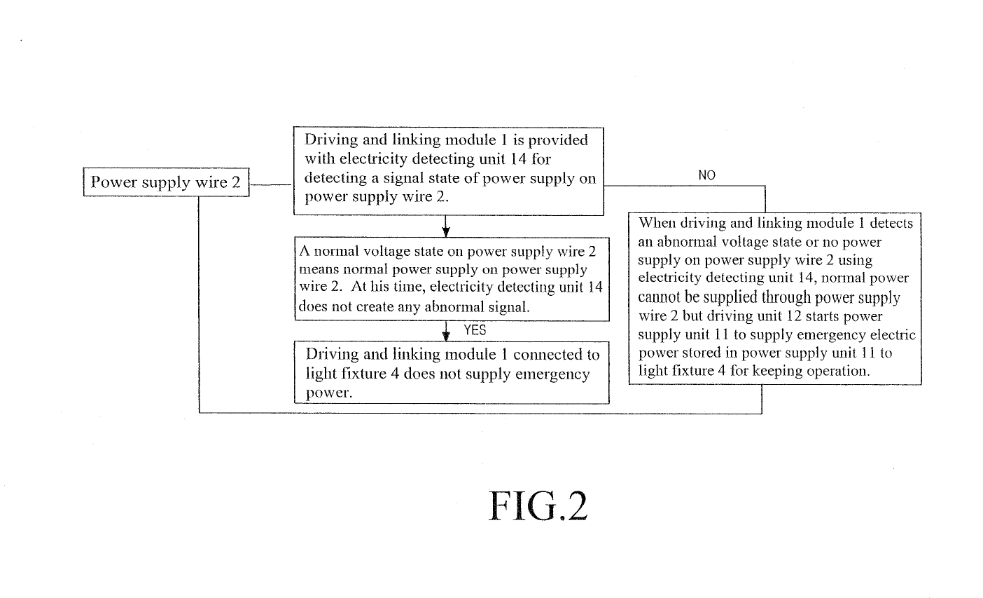

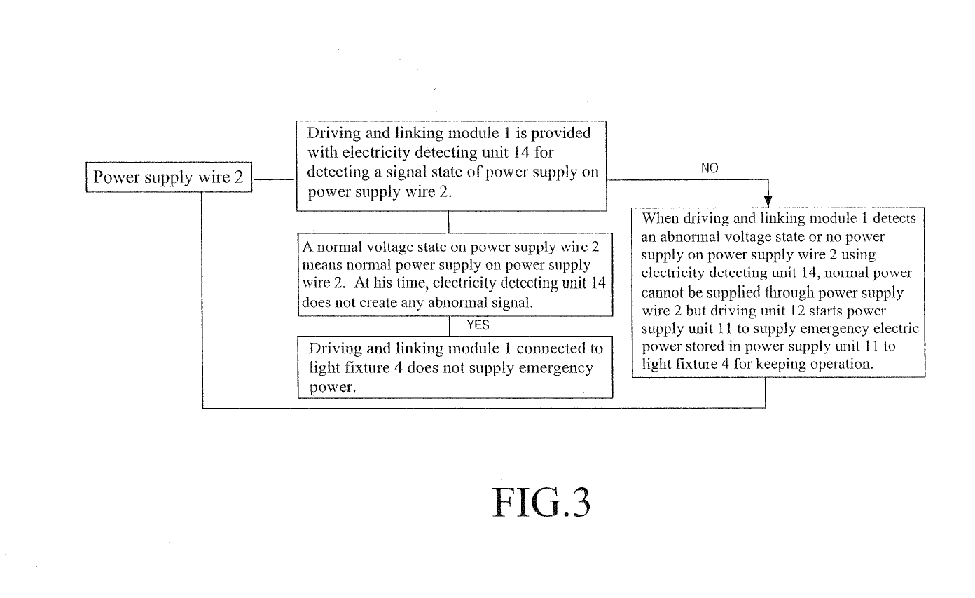

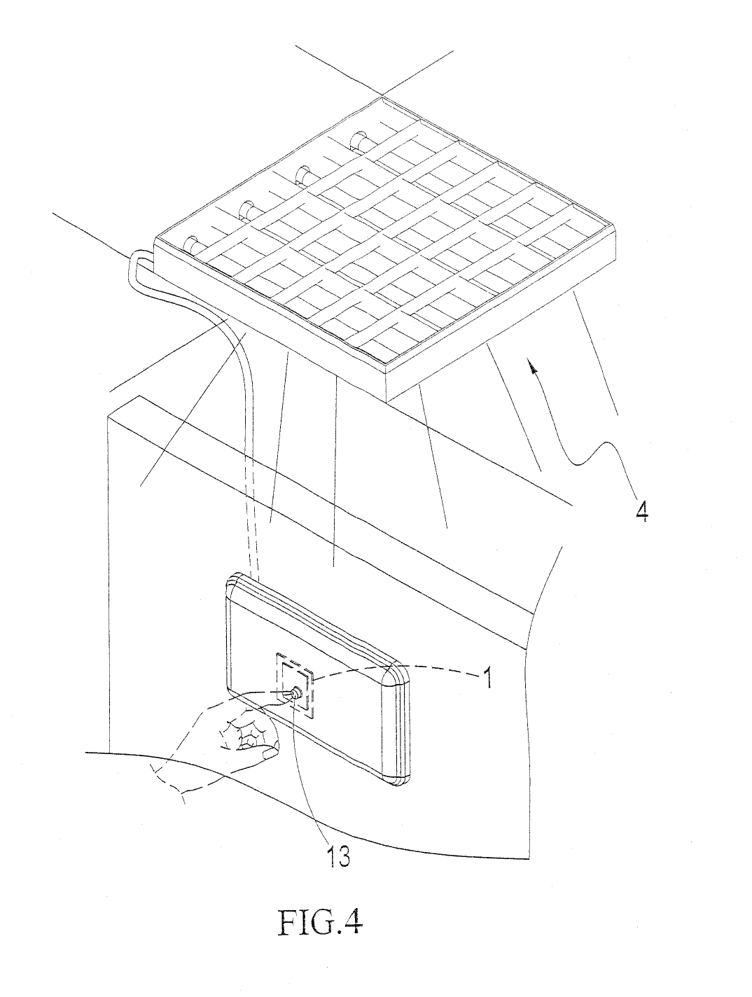

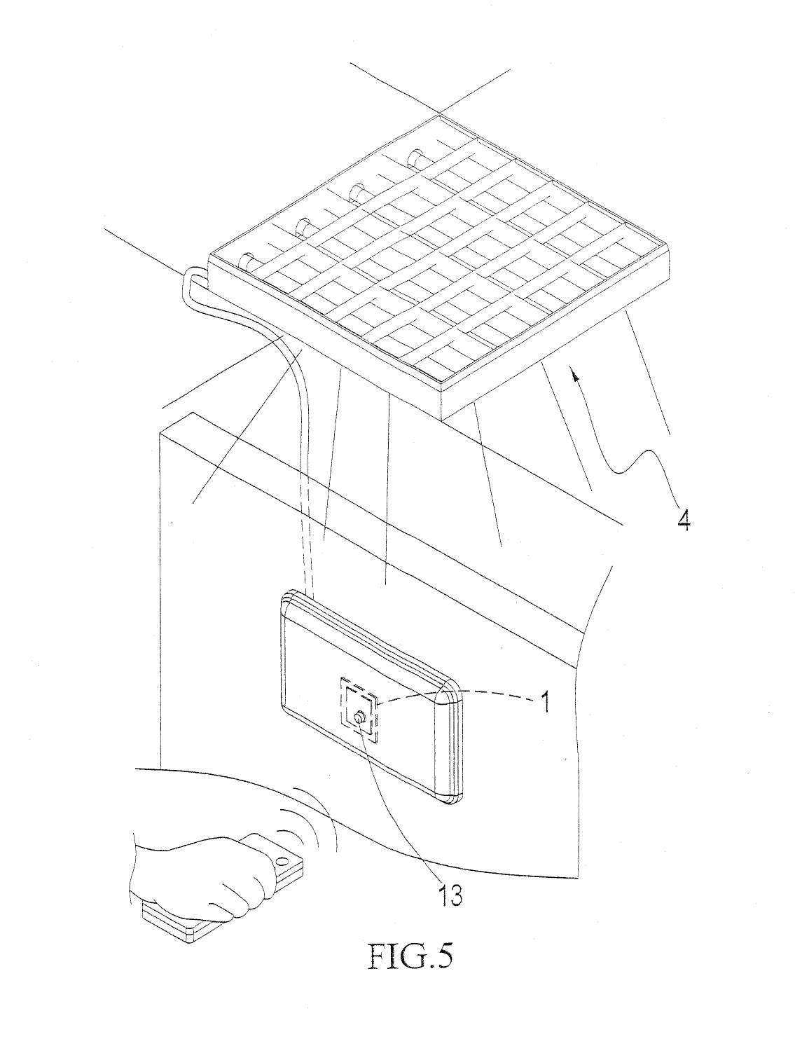

With regards to the above structure, operation, in accordance with the present invention, is described as below. Referring to FIGS. 1-5, a block flow diagram and first through fourth schematic views, the switch 3 in operation is turned on such that the driving and linking module 1 is provided with the electricity detecting unit 14 for detecting a signal state of power supply on the power supply wire 2. A normal voltage state on the power supply wire 2 means normal power supply on the power supply wire 2. At his time, the electricity detecting unit 14 does not create any abnormal signal and the driving unit 12 does not operate to transmit any signal representing abnormal power supply. The driving and linking module 1 does not supply emergency power. At this time, a user can use the control unit 13 to control illumination of the light emitting element 41 having a terminal connected to the light fixture 4, such as light bulb, light lamp or down light, wherein the control unit 13 can be a wired or wireless switch, wherein the wired switch can be a mechanical switch and the wireless switch can be a remote switch controller. At the same time, the electricity charging unit 10 operates to enhance or keep electric power in the power supply unit 11.

When the driving and linking module 1 detects an abnormal voltage state or no power supply on the power supply wire 2 using the electricity detecting unit 14, normal power cannot be supplied through the power supply wire 2 but the driving unit 12 starts the power supply unit 11 to supply emergency electric power stored in the power supply unit 11 to the light fixture 4, such as light bulb, light lamp or down light, for keeping operation.

Accordingly, compared with the prior art, the present invention has the following advantages:

1. The probability of missing signals and thus mistaking to start the light fixture 4 can be dramatically reduced, and this kind of problems can be effectively avoided.

2. The original power supply system can be kept and the effects of uninterrupted power supply also can be achieved.

3. The original power supply wire 2 can be kept with the features of uninterrupted power supply.

4. A plurality of the light fixture 4 can be simultaneously controlled using wired or wireless switches. With respect to each light fixture 4, each corresponding driving and linking module 1 can operate when power supply is interrupted.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. An uninterrupted power supply and detection device comprising:
at least a driving and linking module;
an electricity charging unit contained in the driving and linking module;
a power supply unit coupled to and operating with the electricity charging unit and contained in the driving and linking module;
a driving unit, for starting operation of the power supply unit, contained in the driving and linking module;
a control unit contained in the driving and linking module; and
an electricity detecting unit operating with the driving unit and contained in the driving and linking module.

2. The uninterrupted power supply and detection device of claim 1, wherein the driving and linking module is connected to a power supply wire.

3. The uninterrupted power supply and detection device of claim 2, wherein a switch is set between the driving and linking module and the power supply wire.

4. The uninterrupted power supply and detection device of claim 1, wherein the driving and linking module operates with a light fixture, wherein the light fixture comprises at least a light emitting element.

5. The uninterrupted power supply and detection device of claim 4, wherein the driving and linking module has a function of supplying emergency power to drive operation of the light fixture.

6. The uninterrupted power supply and detection device of claim 4, wherein the light emitting element comprises a halogen lamp, incandescent lamp, fluorescent lamp or light emitting diode.

7. The uninterrupted power supply and detection device of claim 4, wherein the light fixture comprises a light bulb, light lamp or down light.

8. The uninterrupted power supply and detection device of claim 1, wherein the control unit comprises a wired or wireless switch.

9. The uninterrupted power supply and detection device of claim 8, wherein the wired switch comprises a mechanical switch.

10. The uninterrupted power supply and detection device of claim 8, wherein the wireless switch comprises a remote switch controller.
